(19) United States
(12) Patent Application Publication
(10) Pub. No.: US 2007/0079366 A1
(43) Pub. Date: Apr. 5, 2007

(54) Stateless bi-directional proxy

(75) Inventor: Jason Todd Geffner, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/242,562

(22) Filed: Oct. 3, 2005

(51) Int. Cl. G06F 15/16

(52) U.S. Cl. 726/12

(57) ABSTRACT

A system and a method for redirecting data packets, the system comprising a stateless bi-directional proxy for redirecting data packets, said data packets including a header and a body, said header including a source address that identifies the source of the data packet and a destination address that identifies the destination of the data packet. The stateless bi-directional proxy comprises: a first and second input/output interfaces for receiving and sending data packets; a storage component for storing source and destination addresses; and a processing component for changing the source and destination addresses of the received data packets to stored source and destination addresses.

### BACKGROUND

Since its inception, the Internet has been gaining in popularity at an exponential rate throughout the world. Each year hundreds of thousands of computer systems, that include client machines (“clients”), i.e., user devices, and server machines (“servers”), are added to the Internet as more and more people and businesses use the Internet to connect to other people and businesses, and to the myriad sources of information, services, and goods available via Internet servers. As in any large and complex market, the servers and clients connected to the Internet have become targets of malicious parties. Malicious parties use software to gain unauthorized access to confidential and proprietary information belonging to individuals, financial institutions, government, and other businesses stored on both servers and clients. The number and frequency of use of malicious software programs, such as viruses, worms, Trojans, spam (unwanted, unsolicited, and usually commercial electronic mail messages) and the like, collectively referred to as malware, has increased substantially over the last few years. To protect access to systems and confidential data and preserve network data bandwidth, the development and use of anti-malware software has also rapidly increased. The use of suites of anti-malware software, including anti-virus and spam-guards, and other protective software, has become more common. Examples of anti-malware software suites are the Norton AntiVirus and McAfee VirusScan suites of Internet protection software.

Like any new software application, anti-malware software has to be tested in a realistic environment to ensure reliability and proper functionality. Software testing is generally carried out in controlled environments where operating parameters and configurations can be closely controlled so that tests focused on particular areas of functionality can be conducted and the results studied. Because most malware is essentially executable software used in a networked environment, testing anti-malware software requires a controlled network environment. Virus type malware is executable software that is spread by infecting non-infected computer or computing device programs. Infect means to embed a malicious piece of software code (i.e., the malware) in an existing legitimate software program. The embedded malware is subsequently executed by the computer processor when a legitimate software program is chosen by the user for execution by the processor or chosen for execution by other legitimate processes during normal computing activity. The malware causes the damage the malware was designed to accomplish when the malware is executed by the processor. Most malware, especially viruses, circulate on the Internet and are transferred from one computer (i.e., server or client) to another via e-mail attachments, and execute when the e-mail attachment is unwittingly opened by a user, or as parasitic software attached to or embedded in legitimate software programs or Web pages. Worms, unlike viruses, do not need to be embedded in a program to be executed. Once a worm is executed, the worm replicates itself and creates more worms, eventually consuming the bandwidth of the network, thereby not allowing other programs the use of the related computing resources.

To test the effectiveness of anti-malware software, a test system running anti-malware software must be able to receive malware packets sent by a malware system running a malware software program. The test system that receives the malware packets allows a tester, human, or automated computer test software, to observe whether the anti-malware software properly detects the malware packets and prevents them from infecting the test system. Most malware generates random network addresses, such as Internet Protocol (“IP”) addresses, that randomly target computers on the Internet for the delivery of malware. Because the random network addresses generated by malware are highly unlikely to match the network address of a test system, it is unlikely that a test system will receive the packets generated by the malware running on the malware system. What is needed is a way of ensuring that malware packets are directed to a test system so that the effectiveness of anti-malware software running on the test system can be determined

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and a system for directing data packet traffic are provided. A proxy device couples first and second computing devices, systems, or networks together. The proxy device receives data packets from one of the first and second computing devices, systems, or networks addressed to destinations and redirects the data packets to the other of the first and second computing device, system, or network. The proxy device may receive data packets from the other of the first and second computing device, system, or network in response to the packets received by the other of the first and second computing device, system, or network and redirects the response data packets back to the originating one of the first and second computing device, system, or network.

In one exemplary embodiment, the originating one of the first and second computing device, system, or network runs malicious software (“malware”) whereby the original data packets contain malware, and the other of the first and second computing device, system, or network runs anti-malware test software.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating a two-computer system including a stateless bi-directional proxy device;

FIG. 2 is a flow diagram illustrating the operation of the stateless bi-directional proxy device illustrated in FIG. 1;

FIG. 3 is a pictorial diagram illustrating a multiple-computer network system, including a stateless bi-directional proxy device;

FIG. 4 is a flow diagram illustrating the operation of the stateless bi-directional proxy device illustrated in FIG. 3 and related elements;

FIG. 5 is a block diagram of an exemplary embodiment of a stateless bi-directional proxy device; and

FIG. 6 is a block diagram of another exemplary embodiment of a stateless bi-directional proxy device.

### DETAILED DESCRIPTION

A system and a method for redirecting computer network data packets are described. While the system and method are ideally suited for redirecting data packets from a malware system running malware software to a host system running anti-malware software, the system and method may also find use in other environments. Further, while the system and method are described in bi-directional environments, the system and method may also find use in unidirectional environments. Thus, it is to be understood that the present invention should not be construed as limited in application to the exemplary embodiments described herein, and such exemplary embodiments should not be construed as limiting.

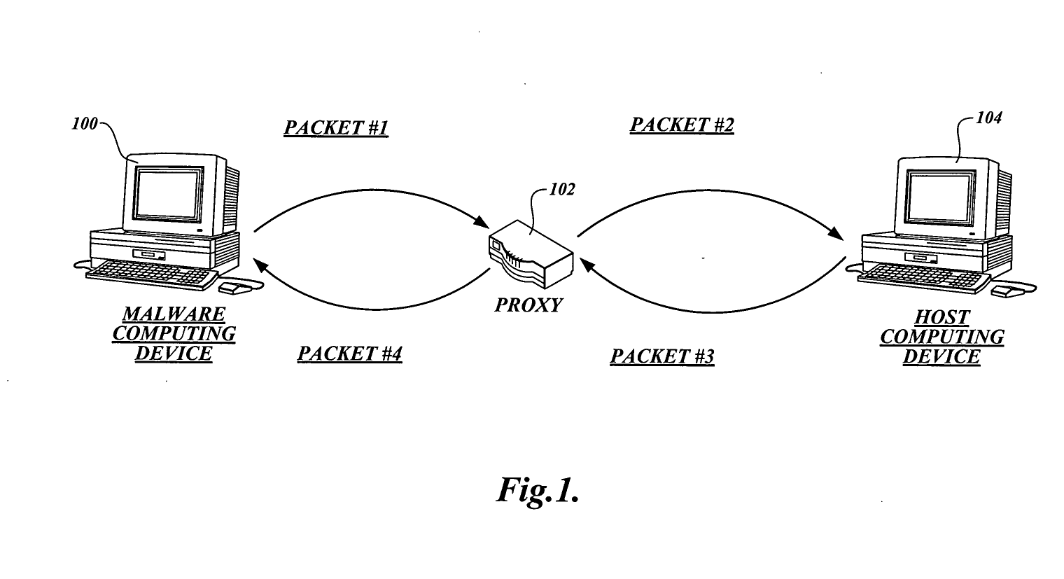

FIG. 1 illustrates a two-computing device system comprising a malware computing device 100, a host computing device 104, and a proxy device 102. The proxy device 102 is a bi-directional stateless device that has two input/output couplings or connections. One input/output coupling or connection is wired or wirelessly connected to the malware computing device 100, and the other input/output coupling or connection is wired or wirelessly connected to the host computing device 104.

While the malware and host computing devices 100, 104 are pictorially illustrated as desktop type personal computers, this should be construed as exemplary and not as limiting. Rather than desktop type personal computers, either or both of the malware and host computing devices 100, 104 could take the form of any of a variety of other computing devices, including, but not limited to, laptop computers, personal digital assistants, cell phones, servers, etc.

The proxy device 102 receives data packets from the malware computing device and forwards them to the host computing device and vice versa. For ease of illustration and understanding, the data packets generated by the malware computing device 100 are designated Packet #1, the data packets forwarded to the host computing device 104 by the proxy device 102 are designated Packet #2, the data packets generated by the host computing device 104 are designated Packet #3, and the data packets forwarded to the malware computing device 100 by the proxy device 102 are designated Packet #4. Each data packet, such as Packet #1, includes a source address and a destination address, each address identifying one end-point of the communication path of the data packet. The source and destination addresses may be Internet Protocol (IP) addresses, for example. Additionally, each data packet may include a media access control (“MAC”) address for the source and destination computing devices, each MAC address uniquely identifying the source and destination computing device, respectively. In the exemplary embodiment illustrated in FIG. 1, depending on which computing device is sending and which computing device is receiving, the source and destination computing devices are the malware computing device and the host computing device.

Returning to FIG. 1, malware software running on the malware computing device 100 applies random destination addresses to the Packet #1 data packets. These packets contain malware. The proxy device 102 receives the Packet #1 data packets, modifies the source and destination addresses such that the Packet #1 data packets are redirected to the host computing device 104 as Packet #2 data packets. The proxy device also modifies the source and destination addresses of response packets, i.e., Packet #3 data packets produced by the host computing device 104, and redirects the response packets to the malware computing device as Packet #4 data packets. More specifically, the proxy device 102 includes a memory that stores the MAC address and IP address of the malware computing device 100 and the MAC address and IP address of the host computing device 104. The aforementioned information stored in the proxy device 102 allows the proxy device 102 to operate in a stateless manner. That is, this configuration information makes it possible for the proxy device 102 to operate without maintaining state information, namely MAC and IP, for each packet it receives and sends. The network connecting the malware computing device to the host computing device is, in effect, switched by the proxy device 102. The malware computing device 100 and the host computing device 104 cannot directly detect the presence of each other on the connecting network and, thus, cannot send network data packets directly to each other. In effect, each of the malware computing device 100 and the host computing device 104 is in a separate sub-network connected through the proxy device 102. In this respect, the proxy device 102 functions as a network router.

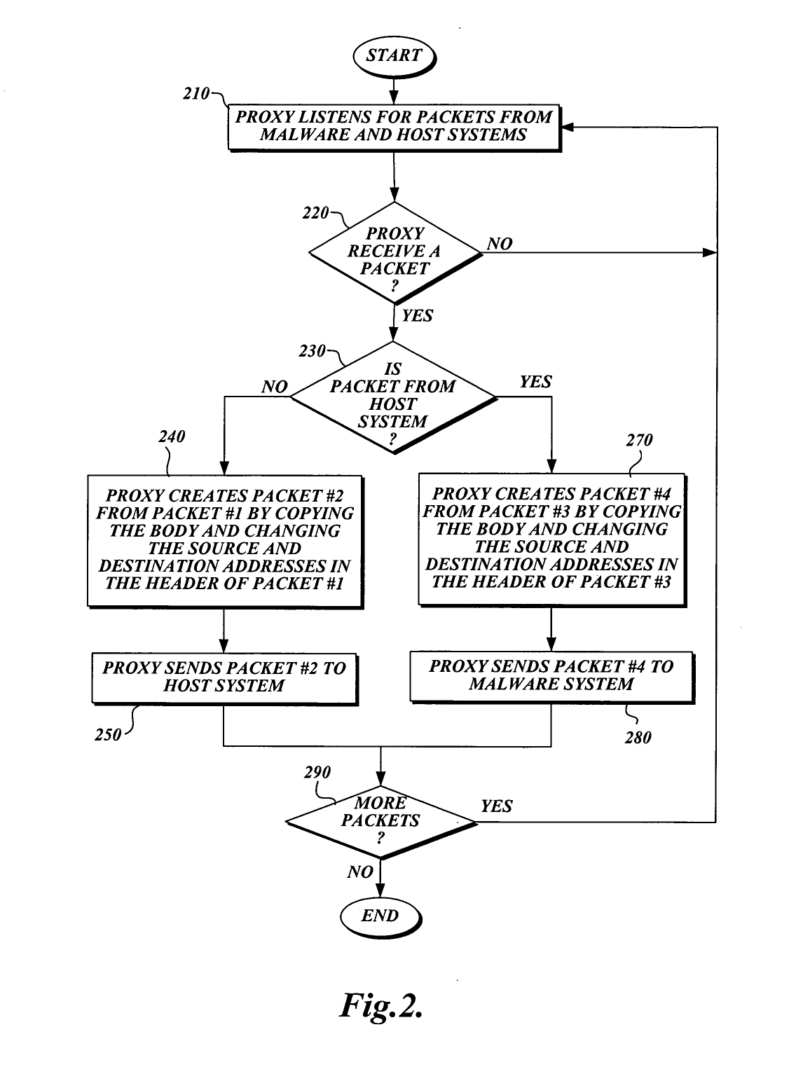

FIG. 2 is a functional flow diagram that illustrates how software stored in the proxy device 102 causes a proxy processor to redirect data packets between the malware computing device 100 and the host computing device 104 by modifying source and destination addresses. Initially, at block 210, the proxy device 102 “listens” for packets from both the malware computing device 100 and the host computing device 104. When a packet is received (block 220), the proxy device 102 determines at block 230 whether the packet is from the host computing device. If the packet is not from the host computing device 104, the packet is from the malware computing device 100. In the illustrated exemplary embodiment of the invention, packets sent by the malware computing device 100, i.e., Packet #1 data packets include a source MAC address set to a value of Malware_MAC (the MAC address of the malware computing device 100) and a source network address set to a value of Malware_IP, the network address of the malware computing device 100. Additionally, Packet #1 data packets include a destination MAC address set to a value of Proxy_MAC (the MAC address of the proxy device 102) and a destination network address set to a value of Target_IP. The value Target_IP is a random receiving computing device address generated by the malware software running on the malware computing device 100.

Returning to FIG. 2, upon receipt of a Packet #1 data packet, the flow diagram passes to block 240 where the proxy device 102 changes the source MAC address to Proxy_MAC and the source network address to Target_IP. The proxy device 102 also changes the destination MAC address to Host_MAC (the MAC address of the host computing device 104) and the destination network address to Host_IP (the network address of the host computing device 104). These changes convert Packet #1 data packets to Packet #2 data packets. While the body of Packet #2 data packets are the same as the body of Packet #1 data packets, the source and destination addresses are different, having been changed in the manner described above. While the source and destination addresses of the proxy and the malware and host computing devices in the herein described exemplary embodiment are IP addresses, obviously, other addresses can be used, depending on the environment of use. Next, at block 250, the proxy device 102 sends the Packet #2 data packet to the host computing device 104. Neither the malware computing device 100 nor the host computing device 104 has any knowledge of the redirection of Packet #1 data packets. At block 290, if more packets are expected, the flow returns to block 210 to listen for more packets. If no more packets are expected, the flow ends.

Returning to block 230, if the received packet is from the host computing device rather than the malware computing device, the received data packet is a response data packet. That is, the data packet is a Packet #3 data packet. In this case, the flow diagram proceeds to block 270 where the proxy device 102 converts Packet #3 data packets to Packet #4 data packets. More specifically, Packet #3 data packets include a source MAC address of Host_MAC and a source network address of Host_IP. Additionally, Packet #3 data packets include a destination MAC address of Proxy_MAC and a destination network address of Target_IP. The proxy device 102 changes each Packet #3 data packet to a Packet #4 data packet. This is accomplished by changing the source MAC address to Proxy_MAC, the source network address to Target_IP, the destination MAC address to Malware_MAC, and the destination network address to Malware_IP (the network address of the malware computing device 100). Thus, as with Packet #1 and Packet #2 data packets, the body of the Packet #3 and Packet #4 data packets is not changed, only the source and destination addresses in the packet header is changed. Next, at block 280, the proxy device 102 sends the Packet #4 data packet to the malware computing device 100. Thus, malware computing device 100 receives a redirected Packet #3 data packet as a Packet #4 data packet. Again, neither the malware computing device 100 nor the host computing device 104 have any knowledge of the Packet #3 data packet redirection. As before, at block 290, if more packets are expected, the flow returns to block 210 to listen for more packets. If no more packets are expected, the flow ends.

In summary, the proxy device 102 redirects data packets originating at the malware computing device 100 to the host computing device 104 and redirects response data packets to the malware computing device 100 without either of the source or destination systems, i.e., the malware computing device 100 or the host computing device, being aware of the redirection.

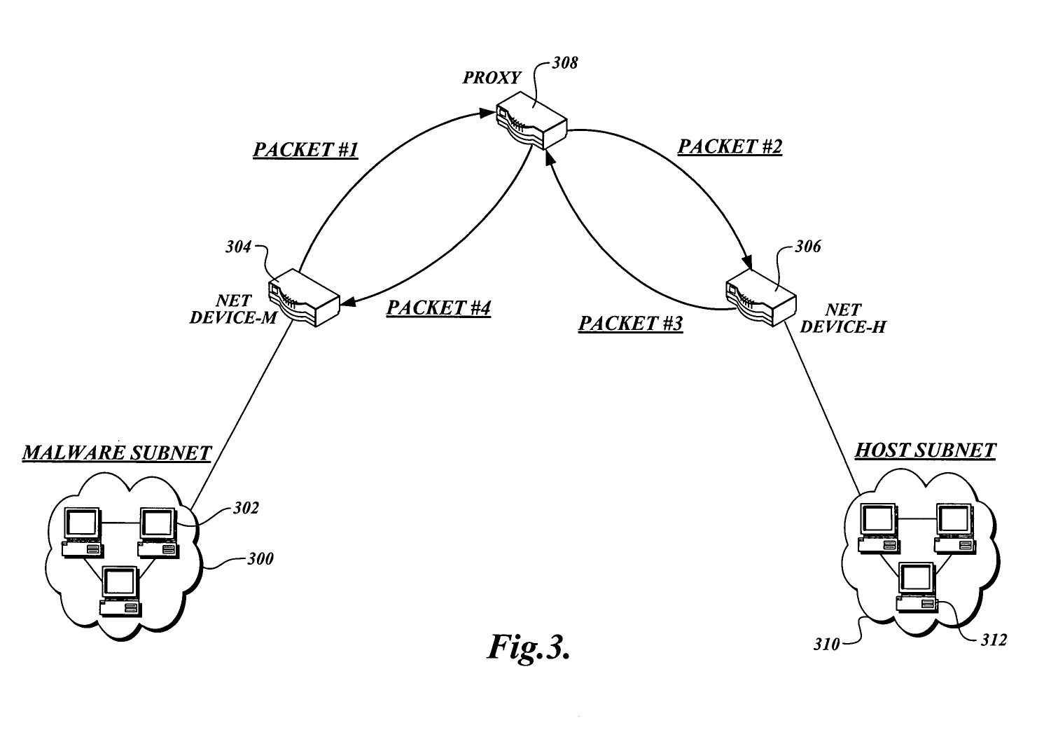

FIG. 3 illustrates a multiple-computer network system that includes a stateless bi-directional proxy device 308. In the exemplary configuration illustrated by FIG. 3, the proxy device 308 couples two subnets, namely a malware subnet 300 and a host subnet 310. The malware subnet 300 includes multiple computing devices, e.g., personal computers or other computing devices, at least one of which is a malware computing device 302, and the host subnet 310 includes multiple host computing devices including a host computing device 312. The malware subnet 300 is coupled to the proxy device 308 via a network coupling device 304 identified as Net Device-M. Likewise, the host subnet 310 is coupled to the proxy device 308 via another network coupling device 306 identified as Net Device-H. In one exemplary embodiment, the network devices 304 and 306 are network routers suitably connecting one subnet to another subnet. In this exemplary embodiment, the proxy device 308 performs a subset of the functions of a router, namely the receiving and routing of data packets from the subnets to which it is connected via the network coupling devices 304 and 306. In this embodiment, techniques such as port-forwarding may be utilized to forward a data packet to a particular system connected to a router. In port-forwarding schemes, a communications port number is included in the network address of the computing device to which packets are directed. The computing device responds to (i.e., accepts) data packets that include the communications port number. Port-forwarding uses a port number to effectively extend a single network address, such as an IP address, for use by multiple computing devices, each such computing device typically responding to a particular application on a particular port number. For example, hyper text transport protocol (“HTTP”), used for Web browsing, requires port 80 to function, and file transfer protocol (“FTP”) requires port 21. If a network packet contains HTTP information, the port-forwarding scheme causes the packet to be directed to a computing device associated with port 80. Port-forwarding may also be used on a single computing device serving multiple applications, such as Web browsing and FTP. In another exemplary embodiment, the network devices 304 and 306 are network hubs, i.e., a hub that replicates a network connection to the multiple computing devices of a network. In this embodiment, the proxy device 308 includes the functions of a router that connects the malware subnet to the host subnet.

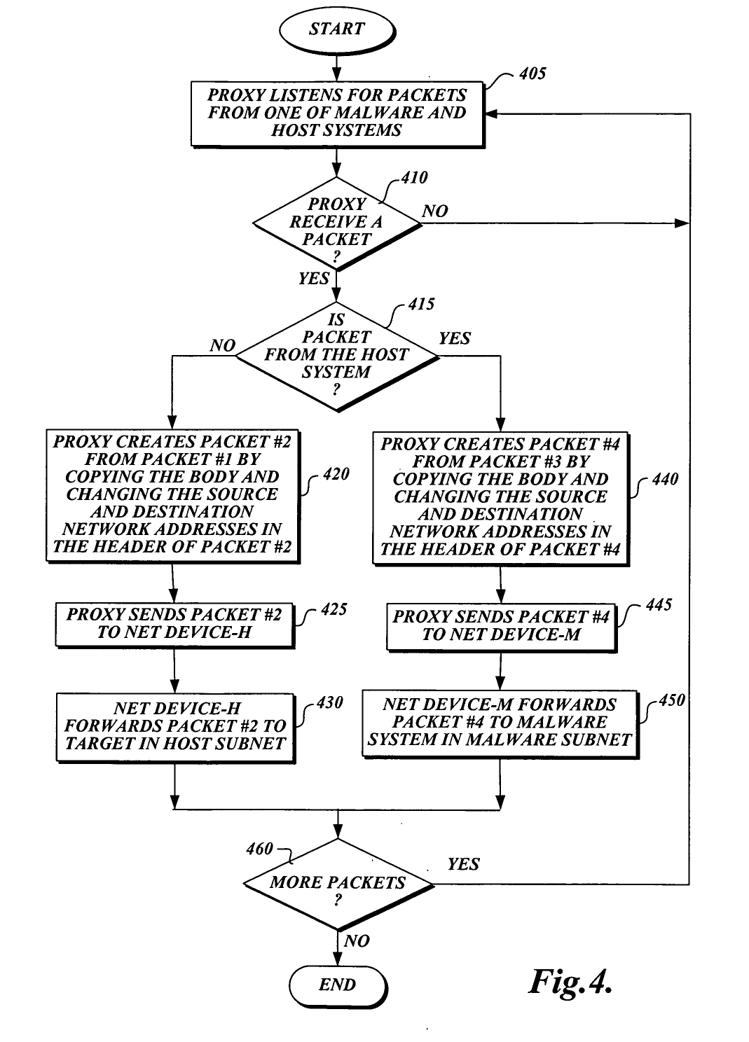

FIG. 4 is a flow diagram that illustrates how the proxy device 308 and the network computing devices 304 and 306 redirect data packets between the malware computing device 302 to a host computing device 312 included in the host subnet 310. The operation of the FIG. 3 proxy device and the network connecting devices is substantially similar to the operation of the FIG. 1 proxy device 102, even though FIG. 4 is different from FIG. 1 in that FIG. 4 includes multiple computing devices in each of the subnets 300 and 310 as well as the network connecting devices 304 and 306 that connect the malware and host subnets 300 and 310 to the proxy device 308.

The FIG. 4 flow proceeds to block 405 where the proxy device 308 monitors the malware and host subnets, i.e., by listening for suitable data packets, i.e., a data packet from either the malware computing device 302 or the host computing device 312. Other data packets are ignored. When the proxy device 310 receives (block 410) a suitable data packet, at block 415 the proxy device determines whether the packet is from the host computing device 312. If the packet is not from the host computing device 302, the data packet is from the malware computing device 312. In this case, the flow proceeds to block 420 where the Packet #1 data packet, i.e., the malware computing device data packet, is changed to a Packet #2 data packet by copying the body of the Packet #1 data packet and changing the network identifications and addresses in the header, as generally described above with respect to FIG. 2. Next, at block 425, the proxy device 308 sends the Packet #2 data packet to network connecting device 306 connected to the host subnet, i.e., Net Device-H. As noted above, the network connecting device 306 may take several forms. In one exemplary embodiment, the network connecting devices 304 and 306 are routers that connect the external network traffic from proxy device 308 to the related subnet 300 or 310. Routers use techniques, such as port-forwarding, described above, to forward data packets to a particular computing device connected to the network connecting device 306. In the exemplary configuration shown in FIG. 3, Packet #2 data packets are routed by the Net Device-H to the target host computing device 312. The routing is based on the common network address and the designated port number of the target host computing device 312. Alternatively, the Net Device-H may assign a distinct network addresses (e.g., an IP) to each host computing device 312, whereby Packet #2 data packets are delivered to the target host computing device 312 based on the distinct network address of the target host computing device 312. In another alternative, the Net Device-H 306 is a network hub and the proxy device performs the routing functions between the two connected subnets. In this alternative, the Net Device-H 306 provides an access point to the subnet 310 that contains the host computing device 312. In another alternative (not shown), the proxy device 308 and the network devices 304 and 306 are integrated into a single device that performs the functions of a proxy, a router, and access points to host computing devices 302 and 312. In yet another alternative, the functions of the proxy device 308 and the network connecting devices 304 and 306 are implemented using software instead of hardware. In yet another alternative, the functions of the proxy device 308 and network connecting devices 304 and 306 are implemented using a combination of hardware and software. Thus, as noted above, the configuration illustrated in FIG. 3 should be construed as exemplary and not limiting.

Returning to FIG. 4, next, at block 430, Net Device-H 306 forwards the Packet #2 data packet to the target in the host subnet 310, i.e., the host computing device 312. If there are more packets to be received, at block 460 the flow returns to block 405, otherwise, the flow ends.

Returning to block 415, if the packet is a Packet #3 data packet, i.e., a data packet from the host computing device 312, the flow proceeds to block 440 where the proxy device 308 creates a Packet #4 data packet from Packet #3 data packet by copying the body of the Packet #3 data packet and changing the network identifications and addresses in the header, as generally described above with respect to FIG. 2. Next, at block 445, the proxy device 308 sends the Packet #4 data packet to Net Device-M, which forwards the Packet #4 data packet to the malware computing device 302, or, generally, the same way that Net Device-H forwards Packet #2 data packets. Then, at block 460, if there are more packets to be received, the flow returns to block 405, otherwise, the flow ends.

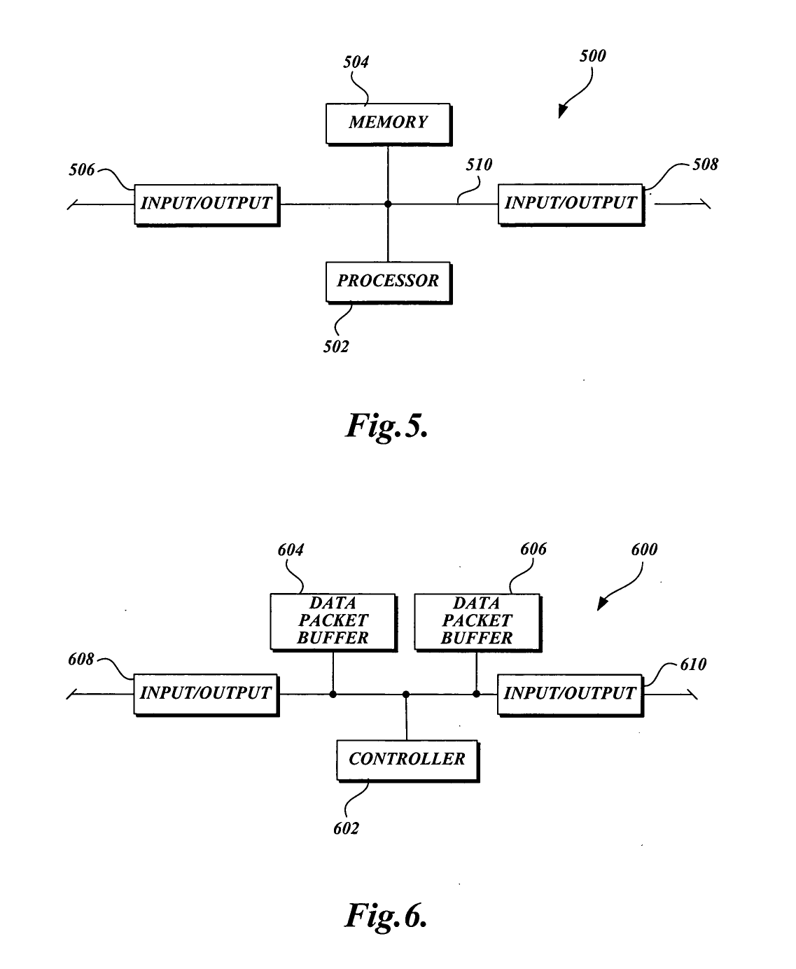

FIG. 5 illustrates an exemplary embodiment of a proxy device 500 suitable for implementation in either software or hardware form. For ease of illustration, only the major hardware or software modules or components are illustrated in FIG. 5, it being understood that actual proxies may include additional modules or components. The exemplary proxy device 500 illustrated in FIG. 5 includes a processor 502, a memory 504, and a pair of input/output interfaces 506,508. As well-known to those skilled in the art, the memory 504 may comprise different sections and each section may be of a different type. For example, the memory 504 may include a dynamic random access memory (“DRAM”) section and a read only memory (“ROM”) or a non-volatile flash type memory. Typically, DRAM is used for the temporary and intermediate storage of data during the execution of proxy software, while ROM or flash memory is used for storing non-volatile data and programs. Data packets are received at one of the input/output interfaces 506 and 508. The received data packets are transferred to the memory 504 via a system bus 510. The processor 502 controls data movement and performs data processing tasks required by the proxy device. More specifically, the processor 502 executes a software program (“proxy software”) stored in the memory 504. The proxy software is stored in the non-volatile part of the memory 504. The non-volatile part of the memory 504 also stores the addresses of the source and destination computing devices, e.g., the malware and host computing devices described above with respect to FIGS. 1 and 3. The proxy software performs the operational functions of the stateless proxy device, e.g., the functions of the stateless bidirectional proxy devices illustrated in FIGS. 2 and 4 and described above. More specifically, the proxy software causes data packets to be redirected by temporarily storing data packets received from one of the input/output interfaces in memory, changing the source and destination addresses in the header of the received data packets, and transmitting the new data packets to a destination using the other of the input/output interfaces 506, 508.

In another embodiment (not shown in the figures) all proxy components, namely, the processor 502, the memory 504, and the input/output interfaces 506 and 508, may be integrated into a single electronic chip. In another embodiment, the input/output interfaces 506 and 508 may be wired network interfaces, such as Ethernet interfaces. In yet another embodiment other components, such as wireless receivers and transmitters, may be used to perform the functions of the input/output interfaces 506 and 508. In still other embodiments, other hardware components, such as a clock generator, extra logic circuits, data buffers, power circuitry, and the like may be included in the proxy device. Thus, as noted above, the proxy components or modules illustrated in FIG. 5 should be construed as exemplary and not limiting.

FIG. 6 illustrates an exemplary embodiment of an alternative proxy device 600 that is ideally suited for implementation in hardware. The proxy device 600 illustrated in FIG. 6 includes a logic control circuit (“controller”) 602, two data packet buffer memories (“data packet buffers”) 604,606, and two input/output interfaces 608, 610. Data packets received at one of the input/output interfaces 608, 610 are transferred to a related one of the data packet relate buffers 604, 606 via a system bus 612. The controller 602 controls computational processes, such as data movement between the input/output interfaces 608, 610 and the data packet buffers 604, 606, as well as other data processing tasks required by the proxy device, namely the proxy functions illustrated in FIGS. 2 and 4 described above. Preferably, the controller 602 is composed of hardware components programmed at low-level for setting operating parameters, such as input/output interface 608, 610 bit-rates. The low-level programming of the controller 602 may be performed, for example, using hardware switches, programmable logic arrays (“PLA”), erasable programmable read only memory (“EPROM”), or other low-level programming devices well-known in the art. The low-level programming may also include setting the source and destination addresses that the proxy uses when redirecting data packets in the manner described above with respect to FIGS. 1-4. Preferably, the buffers 604, 606 comprise memory arrays. For example, the data packet buffers 604, 606 may be DRAM, static RAM type (“SRAM”), or other suitable memory arrays having sufficient access speed. If desired, the proxy may include more than the two data packet buffers shown in FIG. 6. For example, the proxy may include four or six independently addressable buffers for simultaneous bi-directional data packet processing (i.e., full-duplex), and temporary data packet buffers for swapping values while changing data packet addresses. Other combinations of data packet buffers are also possible. The controller 602 causes data contained in the data packets be transferred to and from, and stored in, the data packet buffers 604, 606. As described with respect to FIGS. 2 and 4 above, the controller 602 changes the source and destination addresses in the header of the data packets received from one of the input/output interfaces 608, 610 when creating a new data packet. The new data packet is transmitted to a destination using the other of the input/output interfaces 608, 610.

In yet other embodiments (not shown in the figures) the proxy components, namely, the processor 502 or the controller 602, the memory 504 or the data buffers 604, 606, and the input/output interfaces 506, 508 or 608, 610, may be implemented by a combination of hardware components and software programs. For example, the input/output interfaces 608, 610, and the data buffers 604, 606 may be implemented using hardware components, while the controller 602 may be replaced with a programmable controller similar to the processor 502. Thus, as with FIG. 5, the proxy configuration illustrated in FIG. 6 should be construed as exemplary and not limiting.

The methods and systems described above are ideally suited for use in testing anti-malware software. In such use, the malware computing devices 100 and 302 run malware that generates data packets that contain malware. As noted above, and well known to those skilled in the art, malware data packets are designed to contaminate and/or overload computing devices and/or the elements and components of computing devices. In order to eliminate the problem with the random targeting included in malware data packets, the proxy devices 102 or 308 employed in the exemplary configuration illustrated in FIGS. 1 and 3 redirect malware data packets to specific host computing devices that are running anti-malware software. This arrangement is advantageous in the testing of anti-malware software, because all network packets containing malware are redirected to a known destination(s) under the control of proxy devices 102 and 308, making it possible to collect data and observe how anti-malware software responds to malware data packets.

While exemplary embodiments of the invention have been illustrated and described, it will be appreciated that various changes can be made therein without departing from the spirit and scope of the invention. For example, while the invention is ideally suited for use in testing anti-malware software, embodiments of the invention may find use in other environments. Further, while the illustrated and described proxy devices 102 and 308 operate in a bi-directional manner, uni-directional proxy devices may find use in some environments. Thus, within the scope of the appended claims, it is to be understood that the invention can be practiced otherwise than as specifically described herein.

1. A method of redirecting data packets, said data packets including a header and a body, said header including source and destination addresses, the method comprising:
in response to receiving a data packet from a source, creating a new received data packet by changing the source and destination addresses in the header of the received data packet to predetermined source and destination addresses; and
directing the new received data packet to the destination determined by said predetermined destination address.

2. The method of claim 1 further comprising:
in response to receiving a response data packet from the destination determined by said predetermined destination address, creating a new response data packet by changing the source and destination addresses in the header of said response data packet, said source address being the address of said source; and
redirecting said new response data packet to said source using said source address.

3. The method of claim 2, wherein said predetermined source address is the address of a proxy.

4. The method of claim 2, wherein the source address in the headers of the received data packet and the response data packet each include a source network address, a source network identifier, and wherein the destination address in the headers of a received data packet and a response data packet each include a destination network address and a destination network identifier.

5. The method of claim 4, wherein
(a) creating the new received data packet comprises:
(i) copying the body of the related received data packet; and
(ii) changing the source network address, the source network identifier, the destination network address, and the destination network identifier; and
(b) creating the new response data packet comprises:
(i) copying the body of the related response data packet; and
(ii) changing the source network address, the source network identifier, the destination network address and the destination network identifier.

6. The method of claim 5, wherein the source and destination network addresses are Internet Protocol (“IP”) addresses and the source and destination network identifiers are Media Access Control (“MAC”) addresses.

7. A method of directing malware data packets to a computing device running anti-malware software, said malware data packets including a header and a body, said header including a malware source address that identifies the source of the malware data packets and a randomly generated destination address, the method comprising:
in response to receiving a malware data packet, creating a new malware data packet by changing the malware source address to a predetermined source address and changing the randomly generated destination address to the address of the computing device running the anti-malware software; and
forwarding the new malware data packet to the computing device running the anti-malware software.

8. The method of claim 7 further comprising:
in response to receiving a response data packet from said computing device running said anti-malware software produced by said computing device running said anti-malware software in response to the receipt of the new malware data packet, creating a new response data packet by changing the destination address contained in the header of the response data packet to the malware source address and changing the source address contained in the header of the response data packet to the randomly generated destination address.

9. The method of claim 8 wherein the predetermined source address includes an address of a proxy.

10. The method of claim 7 wherein the malware source address includes a malware source network address and a malware source network identifier and wherein the randomly generated destination address includes a destination network address and a destination network identifier.

11. The method of claim 10 wherein creating the new malware data packet comprises:
(a) copying the body of the related malware data packet;
(b) changing the malware source network address and the malware source network identifier to a randomly generated destination network address and a predetermined source network identifier, respectively; and
(c) changing the destination address and the destination network identifier to a destination address and a destination network identifier related to the computing device running the anti-malware software.

12. The method of claim 11 wherein the source and destination network addresses are Internet Protocol (“IP”) addresses and the source and network identifiers are Media Access Control (“MAC”) addresses.

13. A stateless proxy for redirecting data packets, said data packets including a header and a body, said header including a source address that identifies the source of the data packet and a destination address that identifies the destination of the data packet, said stateless proxy comprising:
(a) a first input/output interface for receiving and sending data packets;
(b) a second input/output interface for receiving and sending data packets;
(c) a storage component for storing source and destination addresses; and
(d) a processing component operable to change the source and destination addresses of the data packets:
(i) in response to one of said first and second input/output interfaces receiving a data packet, creating a new received data packet by changing the source and destination address on the header of the received data packet to source and destination addresses stored in said storage component; and
(ii) directing the new received data packet to the other of said first and second input/output interfaces.

14. The stateless proxy of claim 13 wherein said processing component also:
(i) in response to the other of said first and second input output interfaces receiving a response data packet, creating a new response data packet by changing the source and destination address on the header of the response data packet to other source and destination addresses stored in said storage component; and
(ii) directing the new response data packet to said one of said first and second input/output interfaces.

15. The proxy of claim 13 wherein:
the first and the second input, output interfaces are coupled to first and second networks by first and second network coupling devices; and
the first and the second network coupling devices are one of a router and a network hub.

16. The proxy of claim 13 wherein the new received data packet is created by changing the source and destination addresses in the header of the received data packet and copying the body of the received data packet.

17. The proxy of claim 13 wherein the processing component is a programmable processor that executes a software program stored in said storage component.

18. The proxy of claim 13 wherein the header of the data packets further includes a source network identifier and a destination network identifier.

19. The proxy of claim 18 wherein:
the source and destination addresses are Internet Protocol addresses; and
the source and destination network identifiers are Media Access Control addresses.

20. The proxy of claim 13 wherein the processing component is a logic circuit.
